(19) United States
(12) Patent Application Publication
(10) Pub. No.: US 2013/0175787 A1
(43) Pub. Date: Jul. 11, 2013

(54) Fifth Wheel Locking Mechanism Cover

(71) Applicants: David L'Heureux, Clinton (CA); Bonnie Anfield, Clinton (CA)

(72) Inventors: David L'Heureux, Clinton (CA); Bonnie Anfield, Clinton (CA)

(21) Appl. No.: 13/739,019

(22) Filed: Jan. 11, 2013

Related U.S. Application Data
(60) Provisional application No. 61/585,439, filed on Jan. 11, 2012.

(51) Int. Cl. B60D 1/60

(52) U.S. Cl. CPC B60D 1/60
USPC 280/507

(57) ABSTRACT

A tractor trailer fifth wheel cover is disclosed forming an enclosure over the fifth wheel locking mechanism along the underside of the fifth wheel bearing plate. The cover comprises an upper surface and upstanding sidewalls having a plurality of penetrations therethrough. The cover forms an open interior to accept the fifth wheel kingpin locking mechanism therein and prevents dirt and debris from interfering with the mechanism operation over periods of environmental exposure. The pull handle of the locking mechanism routes through an aperture along the cover sidewall, while the design of the cover is such that it forms an enclosure supported within the underside structure of the bearing plate. The device is fastenably secured to the bearing plate structure and over the locking mechanism, while grease fittings allow lubrication of the locking mechanism assembly therewithin. The cover remains installed during deployment of the fifth wheel without interfering with normal operation.

### CROSS REFERENCE TO RELATED APPLICATION

This application claims the benefit of U.S. Provisional Application No. 61/585,439 filed on Jan. 11, 2012, entitled “Protect and Seal.” The above identified patent application is herein incorporated by reference in its entirety to provide continuity of disclosure.

### BACKGROUND OF THE INVENTION

1. Field of the Invention

The present invention relates to vehicle accessory covers and environmental shrouds. More specifically, the present invention pertains to a tractor trailer fifth wheel cover that covers the underside locking mechanism, preventing dirt and debris from entering and corroding the lock, and thus improving its useful life.

Fifth wheel couplings are removable linkages between a truck or tractor trailer and a towed trailer, whereby the fifth wheel is an assembly that provides a connection point for the trailer to be towed from the lead vehicle, and a platform upon which the trailer can bear upon the lead vehicle for support during operation. The fifth wheel includes a top plate or bearing plate, a throat that accepts a trailer kingpin connection, a locking mechanism for the kingpin, and a sliding adjuster for adjusting the fifth wheel assembly position on the lead vehicle. To secure a trailer, the downwardly directed pin, or “kingpin” of the trailer is secured within a throat of the fifth wheel using a locking mechanism beneath the fifth wheel bearing plate, while the trailer itself rests against the bearing plate upper surface. This assembly is well known in the art of trailer systems, and functions as a highly efficient means of connection between a lead vehicle and a towed trailer. The connection provides a pinned support for the front portion of the trailer, wherefrom the rear wheels of the trailer follow the kingpin lead and allow the lead vehicle to make turns independently of the trailer rear wheels for maneuverability.

Between uses towing a trailer, the fifth wheel assembly is exposed to the environment, whereby the bearing plate and the locking mechanism are open to the outside air. This allows debris sources and foul weather to directly contact the surfaces of the fifth wheel, increasing maintenance and eventually reducing its useful life over a period of exposure. The bearing plate and locking mechanism are generally lubricated to ensure smooth operation and to reduce friction between contacting interfaces. Debris sources such as dirt, stones, sand, and other environmental debris reduce the lubrication of these elements, which results in increased wear.

To address this known problem between uses, various covers have been disclosed in the prior art to cover the bearing plate and the fifth wheel assembly as a whole. These devices generally comprise structures that are secured over the top surface of the bearing plate to prevent wear thereto, but provide little in the way of protection for the locking mechanism below the plate. Further still, most of the covers of the prior art relate to structures that are not capable of being deployed when the fifth wheel is in operation and connected to a towed trailer. Most covers provide utility only when the fifth wheel is not operational and between uses.

To fulfill a need in the art, the present invention discloses a fifth wheel cover that is directed to protecting the locking mechanism beneath the bearing plate. The cover is once that secures over the locking mechanism while allowing the mechanism to function as design without interference, while at the same time preventing stones, sand, water, and other debris sources from contacting the assembly. Discrete debris sources can jam the mechanism, while moisture sources can create corrosion that can damage or seize the mechanism. The present invention is fastened to the underside of the fifth wheel bearing plate and provides grease fittings for periodic lubrication of the mechanism thereunder. Overall, the present cover provides a functional fifth wheel cover that does not require removal when the fifth wheel is secured to a trailer, fulfilling a long felt need in the art for protection of the fifth wheel locking assembly from environmental elements.

### DESCRIPTION OF THE PRIOR ART

Devices have been disclosed in the prior art that relate to fifth wheel cover devices. These include devices that have been patented and published in patent application publications, and generally relate to covers that are not compliant with the fifth wheel system when towing a trailer. The prior art devices provide elastic covers and larger structures that shroud the entire fifth wheel assembly as opposed to covering the locking mechanism only. The present invention shrouds the locking mechanism during and between uses towing a trailer, preventing damage thereto and extending its useful life. The following is a list of devices deemed most relevant to the present disclosure, which are herein described for the purposes of highlighting and differentiating the unique aspects of the present invention, and further highlighting the drawbacks existing in the prior art.

Specifically, U.S. Pat. No. 7,703,791 to Varjassy discloses a fifth wheel cover that comprises a shell spanning over a fifth wheel plate of a tractor trailer, whereby the shells is retained over the outer portion of the fifth wheel plate using a elastomeric material band along its open lower peripheral edge. The elastomeric material forms a continuous band to secure the shell over the entire upper portion of the fifth wheel plate, protecting the assembly from dirt and debris between connections to a trailer. The Varjassy device discloses a flexible material that forms a cap over the exterior portion of the fifth wheel, in a similar fashion as a human head cap. The present invention pertains to a structure the encloses the underside of a fifth wheel cover to protect the fifth wheel locking mechanism from contact with outdoor elements or debris between uses securing a trailer to a tractor trailer chassis. The structure and intent of the present invention differ from that of the Varjassy device, whereby the outer portion of the fifth wheel is left uncovered, as this area has no moving parts that would be interfered with by external debris sources.

Similar to the Varjassy device, U.S. Pat. No. 5,058,914 to Murcheson discloses a slip cover for a tractor trailer bearing plate that protects the plate from debris when not in use. The debris is an abrasive if not cleared from the plate prior to coupling the fifth wheel with a trailer, whereby friction between the plate and the trailer by the abrasive debris therebetween will cause wear to the plate. The cover comprises a sheet conforming to the shape of the plate attaching to a skirt that incorporates releasable fastening cord for securing the sheet around the bearing plate. The present invention pertains to a hardened structure that is designed to fit within an underside cavity of the fifth wheel plate and shield the locking mechanism from external debris sources.

U.S. Pat. No. 6,443,476 to Molock, Jr. discloses an elongated covering for a tractor trailer fifth wheel, whereby the covering comprises a tarpaulin cover extendable from a frame mounted to the tractor trailer chassis that is elevated above the fifth wheel. The tarpaulin is released from a storage means over the fifth wheel to protect the wheel from debris and water between uses, extending its useful life. A pair of guide rollers stow the tarpaulin in a rolled state, whereafter the tarpaulin can be deployed and extended over the fifth wheel when the tractor trailer is not engaged with a trailer. The Molock, Jr. device describes an enlarged frame that supports a tarpaulin cover. The frame must be supported on the tractor trailer chassis. The present invention comprises a covering that is adapted to fit within the fifth wheel plate underside structure to cover the locking mechanism thereunder. The present invention is not designed to preserve the outer surface of the fifth wheel plate, but rather ensure the coupling mechanism remains functional between extended uses and in foul environments.

U.S. Pat. No. 5,165,713 to Picard discloses another fifth wheel cover that extends over the bearing plate and sloped flanges of the fifth wheel. The cover comprises a circular portion having a pair of tail portions that terminate at cup portion to engage the flanges of the bearing plate. A hook formation is provided along the circular portion opposite of the tail portion to engage the rim of the bearing plate. Similar to the aforementioned prior art devices, the Picard device provides a cover over the outer bearing plate of the fifth wheel, as opposed to a structure that protects the mechanical assemblies beneath the bearing plate.

U.S. Pat. No. 4,169,635 to Szalay discloses a bearing plate cover for a tractor trailer fifth wheel, wherein the cover comprises a flat plastic sheet that is secured over the bearing plate and fastened thereto. The sheet provides a low friction interface once installed, and is coextensively conformed to the bearing plate upper surface. Similar to the Picard device, the Szalay device provides an outer cover the does not protect the underside mechanical assembly from environmental elements that may inhibit its operational over a period of exposure.

Finally, U.S. Pat. No. 5,720,492 to Wanzenried discloses a rigid and removable fifth wheel cover that prevents dirt and debris from becoming lodged into the friction reducing grease covering of the fifth wheel and from falling into the throat of the fifth wheel. Clip locks secure the cover over the bearing plate upper and sides, preventing the cover from being dislodged when deployed. A throat protector is a separate structure that is secured within the throat of the fifth wheel that locks into place over a cross member at the rear of the fifth wheel after the cover is applied. As with the previous references, the Wanzenried device fails to disclose a cover for the locking mechanism along the underside of the fifth wheel, which is a critical mechanical assembly for operating the trailer kingpin lock when coupling and uncoupling the trailer.

The present invention provides an underside cover for a towing vehicle fifth wheel, whereby the locking mechanism that secures the towed vehicle kingpin is shrouded from environmental debris sources. The goal is to prevent mechanical interferences from outside debris, prevent increased wear associated with particulate debris sources that may act as abrasives, and further to prevent corrosion of the functioning elements of the mechanism while maintaining prescribed lubrication thereof. It is submitted that the present invention is substantially diverges in design elements from the prior art, and consequently it is clear that there is a need in the art for an improvement to existing fifth wheel cover devices. In this regard the instant invention substantially fulfills these needs.

### SUMMARY OF THE INVENTION

In view of the foregoing disadvantages inherent in the known types of fifth wheel covers and shrouds now present in the prior art, the present invention provides a new fifth wheel cover that be utilized for providing convenience for the user when shrouding the fifth wheel locking mechanism between and during towing operations.

It is therefore an object of the present invention to provide a new and improved fifth wheel device that has all of the advantages of the prior art and none of the disadvantages.

It is another object of the present invention to provide a fifth wheel device to provide a shroud that cooperates with the underside structure of a fifth wheel bearing plate, whereby the cover secures to the bearing plate underlying structure to shroud the kingpin locking mechanism from environmental debris and moisture.

Another object of the present invention is to provide a fifth wheel device that facilitates coverage of a fifth wheel locking mechanism while not interfering with the normal operation of the fifth wheel, whereby the cover remains installed between and during use coupling to and towing a trailer.

Yet another object of the present invention is to provide a fifth wheel device that provides a secure structure over the locking mechanism and provides cut-outs or apertures in its design to accommodate the structure of the bearing plate and the locking mechanism pull handle from either side of the fifth wheel assembly.

Another object of the present invention is to provide a fifth wheel device that provides grease fittings for supplying lubrication to the locking mechanism assembly under the present cover when deployed, allowing for the mechanism to be maintained and well lubricated without first requiring removal of the present cover.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows an overhead perspective view of an embodiment of the present invention, wherein the pull handle clearance aperture shrouds are shown exploded from the sidewalls of the cover.

FIG. 2 shows an underside perspective view and a direct underside view of an embodiment of the present invention.

FIG. 3 shows an overhead view of an embodiment of the present invention.

FIG. 4 shows an exploded view of the present invention being applied to the underside of a fifth wheel bearing plate and over the locking mechanism.

FIG. 5 shows a view of the present invention in a deployed and working position.

### DETAILED DESCRIPTION OF THE INVENTION

Reference is made herein to the attached drawings. Like reference numerals are used throughout the drawings to depict like or similar elements of the fifth wheel cover. For the purposes of presenting a brief and clear description of the present invention, the preferred embodiment will be discussed as used for shrouding a fifth wheel locking mechanism between and during operation as a towed vehicle coupling device. The figures are intended for representative purposes only and should not be considered to be limiting in any respect.

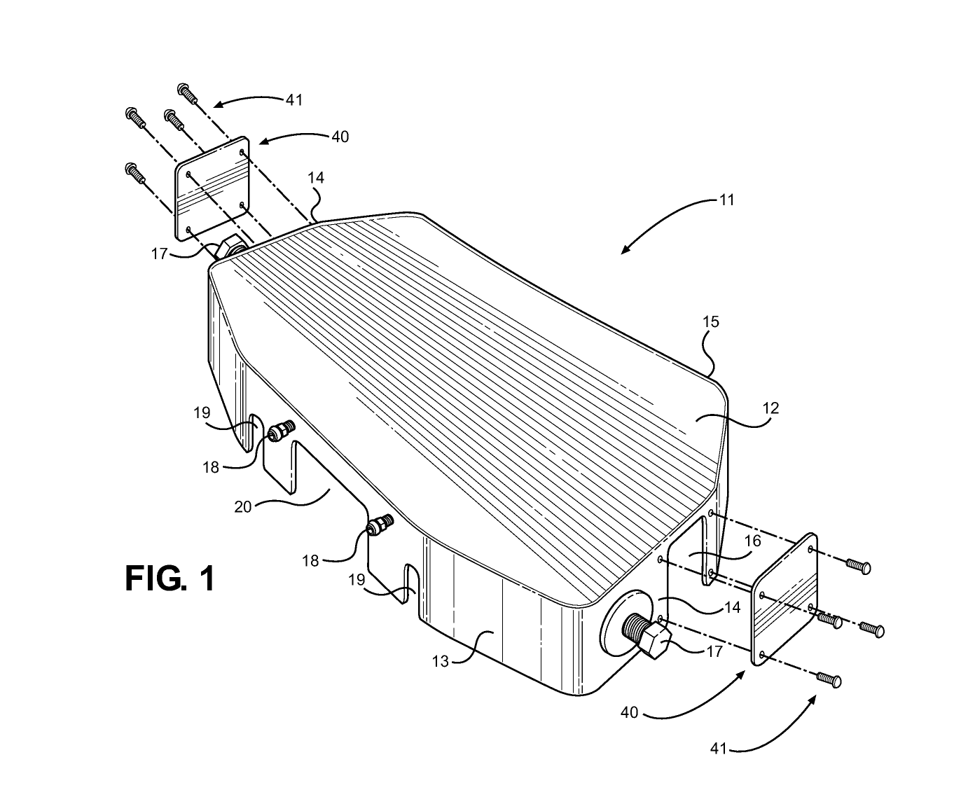

Referring now to FIG. 1, there is shown an overhead perspective view of the fifth wheel cover of the present invention in a partially exploded configuration. The cover 11 comprises an upper surface 12 having a perimeter edge, wherefrom a perimeter sidewall 13 extends perpendicularly from the supper surface 12. The sidewall 13 and upper surface 12 creates an interior cavity having an open bottom to accept a fifth wheel locking assembly therein. Along the sidewalls are a plurality of cut-outs or apertures that provide clearance for the underside structure of the fifth wheel cover plate and the elements of the locking mechanism. These apertures are kept to a minimum and covered in areas where not required to make clearance, thereby creating an enclosed volume over the fifth wheel locking mechanism that does not allow debris and moisture penetration.

The apertures can be categorizes as those providing clearance for structural elements of the fifth wheel and those that provide clearance for the working elements of the locking mechanism. The structural clearance apertures 19 account for flanges, cross members, or other structural features of the fifth wheel underside area, preventing interferences with the cover and a secure fitment thereof to the structure of the fifth wheel cover plate. In the forward sidewall, an enlarged aperture 20 may be provided to make room for the locking mechanism spring tensioner bolt. Along the lateral sidewalls is provided a locking mechanism pull handle aperture 16, which allows the pull handle of the locking mechanism to be directed through either lateral sides of the cover 11 without requiring a different design. The unused pull handle aperture 16 is then covered using a cover plate 40 or liner, which is fastened 41 to the sidewall to close the open and unused aperture 16. This prevents any unnecessary penetrations through the cover 11 and thus ensures a sealed underside volume. Similar apertures may be provided along the backside 15 sidewall to make room for structural members of the bearing plate or the locking mechanism, as required by the specific design and model of fifth wheel being deployed.

To secure the cover, a first and second threaded fastener 17 is provided along the sidewalls, whereby fastener locations on the fifth wheel bearing plate structure provide a means to securely fasten the cover 11 thereto. Once installed, the sidewalls enclose the fifth wheel locking mechanism that is mounted to the bearing plate. This prevents contaminants and environmental debris or moisture from contacting the moving elements of the locking mechanism, thereby preserving it over a period of time when exposed to outdoor elements. The locking mechanism pull handle is accommodated by an aperture 16 in the cover sidewall to allow the cover to remain installed between uses and during use of the fifth wheel. For periodic maintenance and lubrication of the locking assembly, at least one grease nipple 18 is provided that allows a user to insert lubrication into the interior of the cover and onto the locking mechanism. This allows periodic lubrication without removal of the cover 11, saving time and steps for maintenance.

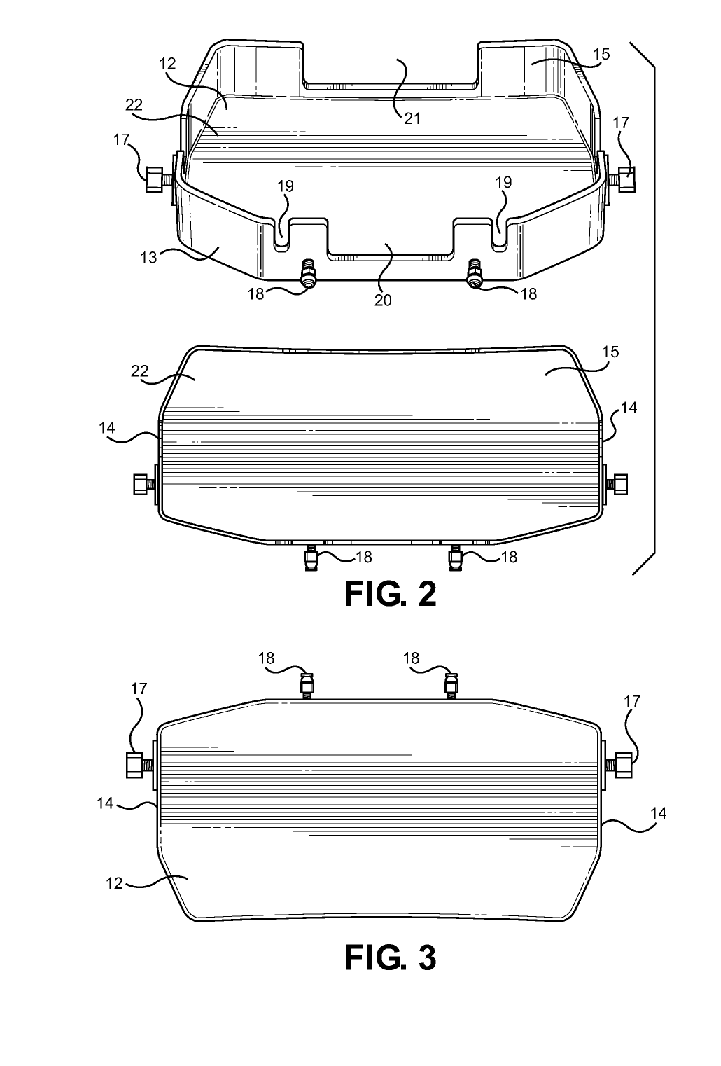

Referring now to FIGS. 2 and 3, there are shown underside views and an overhead view of an embodiment of the present fifth wheel cover. The exact design of the cover, notably its perimeter edge, sidewall design, contour of the upper surface, and placement of apertures is dependent on the specific fifth wheel for which the cover will be secured to. In one embodiment, the cover provides a backside 15 aperture 21 along the cover backside wall 15 and a front side 20 along the forward wall to accommodate the locking mechanism, while a pair of lateral sidewall apertures 14 provides clearance for the pull handle of the locking mechanism in either through the first or second lateral sidewall. Similarly, the cover fasteners 17 are preferably along the lateral sidewalls of the cover; however the fasteners 17 and structural penetration apertures 19 can also be placed in a more advantageous position depending on the geometry of the given fifth wheel cover plate. When installed, the open interior 22 of the cover shrouds the locking mechanism while the grease fittings or nipples 18 allow lubrication insertion within the interior 22 of the cover.

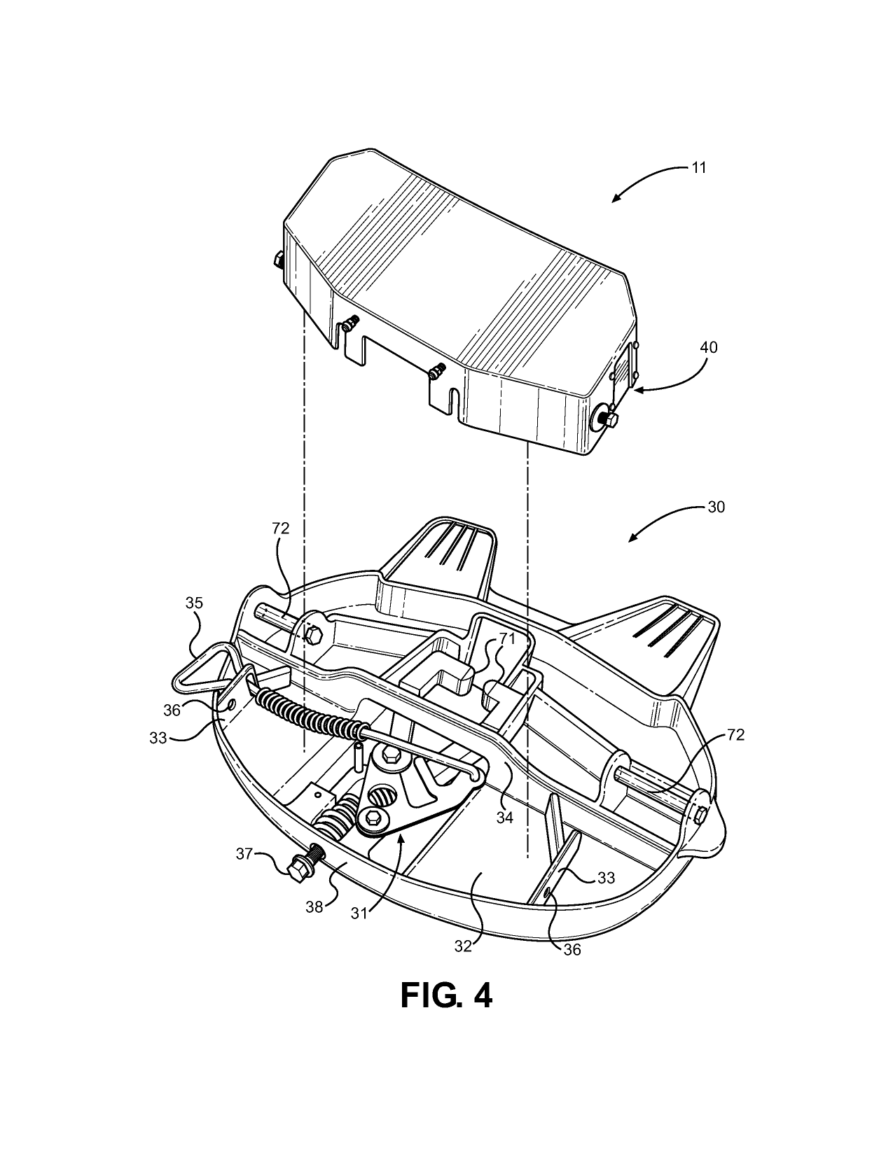

Referring now to FIG. 4, there is shown an exploded perspective view of the present cover 11 being applied to the underside of a fifth wheel bearing plate 30 and over the fifth wheel locking mechanism 31. The fifth wheel plate 30 comprises an upper surface that bears against the towed trailer and an underside structure that is adapted to provide adequate stiffness and strength for the plate 30 during operation, while making sufficient clearance for the locking mechanism 31 connected thereunder. The locking mechanism 31 comprises a tensioned linkage that includes a pull handle 35, a tensioner 37, and an articulating mechanism that controls the operation of locking jaws 71. The jaws 71 secure around the kingpin of a trailer, which is fed through the throat of the fifth wheel. The pull handle 35 allows a user to open the jaw 71, whereafter the kingpin can engage the open jaws 71 that surround and secure the kingpin to the lead vehicle. During the coupling operation, the fifth wheel bearing plate can rotate about pinned supports 72, allowing it to accommodate the underside of the trailer as the kingpin is placed into the open jaws 71 of the locking mechanism.

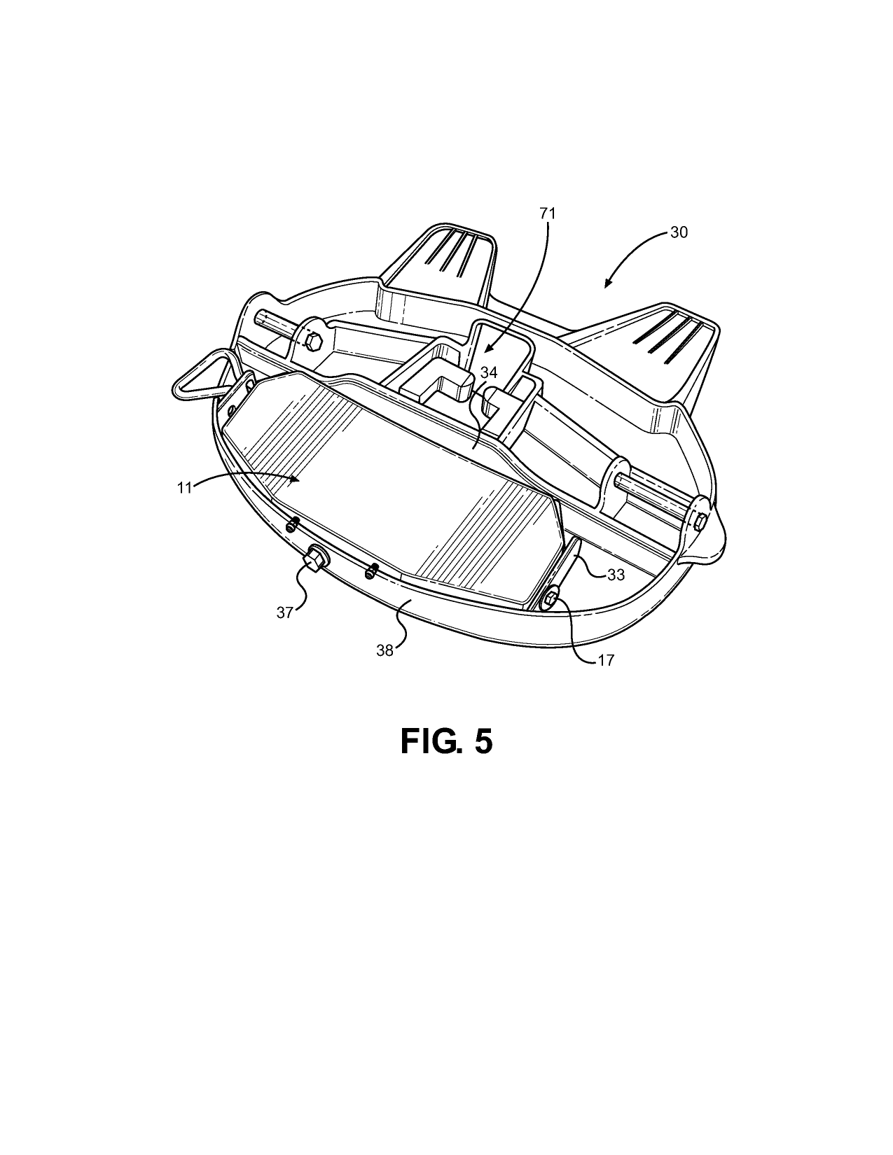

Referring now to FIGS. 4 and 5, the cover 11 is shown covering the locking mechanism 31 and creating a sealed volume thereover. The design of the cover 11 is one that is specific to the given model of fifth wheel, whereby the goal is to provide an enclosure that shrouds the locking mechanism 31 and the underside of the cover plate 30 as thoroughly as possible without interfering with its normal operation. Therefore, the geometry of the cover 11, notably its perimeter shape, sidewall height, and the location of apertures therethrough are specific to a given fifth wheel model. Securing bolts 17 are fed through the fastener holes 36 in the structure 33 of the fifth wheel to secure the cover thereto. Whereafter the grease fittings protrude from a side 38 of the cover plate to provide ready access thereto by the user.

The size and breadth of coverage provided by the cover is specific to the design of the bearing plate structure and its clearances with other aspects of the fifth wheel assembly and lead vehicle. Overall, however, it is desired to disclose a functional cover that provides a secure shroud over the locking mechanism of a fifth wheel, whereby the locking mechanism is mounted to the underside of the bearing plate, and the cover establishes no interferences with the range of motion of the bearing plate that would inhibit its operation. The locking mechanism is shrouded from environmental debris and moisture, while the user can readily apply grease or other lubrication to the mechanism without removing the cover. Finally, the pull handle and tensioner 37 of the locking mechanism is further accessed without removing the cover during deployment.

If fifth wheel assemblies are left unprotected or exposed to the environment for periods of time, they can become worn and may need to be replaced sooner than anticipated. Additionally, the buildup of ice, snow, mud, dirt, and other debris may cause these coupling assemblies cease proper functionality or seize altogether. Excessive buildup can also cause problems with properly coupling and de-coupling the towed trailer, thus causing it to disconnect prematurely or not make positive engagement therewith. This can cause serious danger during towing operations and frustration for the user if attempting to couple the trailer using a fouled fifth wheel. Therefore, the present invention provides a cover that effectively protects the fifth wheel locking mechanism and prevents unexpected wear, ensures improper operation, and prevents seizing of the assembly. The structure of the cover is preferably a polymer plastic or metallic structure, however it is not desired to limit the material of the present invention to one specific type, but rather to disclose a functional cover having utility for tractor trailer and hauling vehicle users.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A fifth wheel cover, comprising:
an upper surface having a perimeter edge;
an upstanding perimeter sidewalls extending from upper surface said perimeter edge;
said upper surface and perimeter sidewalls forming an interior volume having an open bottom;
said perimeter sidewalls formed within an underside fifth wheel bearing plate structure and said interior volume enclosing a fifth wheel locking mechanism attached to said bearing plate;
fasteners between said sidewalls and said bearing plate structure to secure said cover;
at least one aperture along said perimeter sidewalls.

2) The device of claim 1, further comprising at least one grease fitting through said cover to communicate lubrication into said cover interior volume.

3) The device of claim 1, wherein said at least one aperture further comprises a locking mechanism pull handle aperture to accept a pull handle therethrough.

4) The device of claim 1, wherein said at least one aperture further comprises:
a first and second locking mechanism pull handle aperture along opposing lateral sidewalls;
said first pull handle aperture accepting a pull handle therethrough;
said second pull handle aperture being sealed with a cover plate.

5) The device of claim 1, wherein said at least one aperture further comprises a structural clearance aperture for said fifth wheel bearing plate underside structure to prevent interferences therewith.

6) The device of claim 1, wherein said at least one aperture further comprises an locking mechanism tensioner clearance aperture such that said locking mechanism tension may be accessed from outside of said cover interior volume.

7) The device of claim 1, wherein said at least one aperture further comprises a clearance for said locking mechanism kingpin jaws and connecting members therefor.
